(19) United States
(12) Patent Application Publication
(10) Pub. No.: US 2007/0214507 A1
(43) Pub. Date: Sep. 13, 2007

(54) Anti-theft system for optical products

(76) Inventor: Richard H. Selinfreund, Terre Haute, IN (US)

Correspondence Address: KELLEY DRYE & WARREN LLP, 400 ATLANTIC STREET, 13TH FLOOR, STAMFORD, CT, 06901, US

(21) Appl. No.: 11/598,314

(22) Filed: Nov. 13, 2006

Related U.S. Application Data
(60) Provisional application No. 60/739,347, filed on Nov. 23, 2005.

(51) Int. Cl. H04L 9/32

(52) U.S. Cl. 726/26; 726/2

(57) ABSTRACT

A system for reducing supply chain theft comprising a medium having a state-change material associated therewith that is activatable from a first detectable state to a second detectable state by an activating wave that is energetically different from the read-wave of the reader, thereby altering the medium from a limited read medium to a more open read medium; an activation unit operatively configured to direct activating waves to the optical medium such that one-way state-change material associated with such optical medium is activated from a first state to a second; and a verifier unit operatively configured to determine whether the one-way state-change material is its first or second optical state.

### RELATED APPLICATIONS

This application claims priority to U.S. Provisional Patent Application No. 60/739,347 filed Nov. 23, 2005. The disclosure of each such application is hereby incorporated by reference in its entirety where appropriate for teachings of additional or alternative details, features, and/or technical background, and priority is asserted from each.

### BACKGROUND OF THE INVENTION

1. Field of the Invention

The present invention generally relates to a system for reducing theft of optical media from a distribution chain and optical media having anti-theft protection.

2. Description of the Related Art

The development of software and other forms of content data, such as visual and auditory digital data, represents a large investment in time and money. Such content data is often stored in digital form on a transportable storage medium which is then sold to a purchaser. Unfortunately, with most traditional transportable digital recording media, clandestine movement from of the recording medium from its intended distribution path is relatively easy, as is extraction of the data from the transportable storage media. Furthermore, the production of illicit copies of copyrighted material stored on recording medium is relatively simplistic even for the relatively uninitiated in computer science.

To offset the losses occurring in a transportable storage medium distribution chain, as well as illicit copying of information stored on the transportable recording medium, purveyors charge higher prices to retailers. In a similar fashion, to offset the costs of shoplifting of transportable recording medium, retailers pass charge customers higher retail prices. In the end, consumers pay considerably higher prices for recording medium due to such illicit activities.

There have been numerous attempts to curb content data piracy on transportable digital recording media. In one approach, a serial number is placed in the content data to allow for tracing of unauthorized copies of the serialized content data. The problem with this method is that it requires the task of external enforcement to track down illegal copies and is of relatively little use when the item is not associable with a particular person. Further, hackers of a number of such systems have found it relatively easy to locate and erase the serial numbers.

To deter shoplifting and distribution chain theft, some entities employ electronic article surveillance (EAS) systems that include transponder tags (RFID, etc.) attached to each article of merchandise. With respect to transportable digital recording media, such transponder tags are typically associated with the packaging surrounding the media. EAS systems further include one or more electronic readers positioned at exits to detect the transponder tags. When an item is purchased, or is removed from the distribution chain in an authorized manner, the transponder tag is disabled or removed from the article and the merchandise may pass by the reader without sounding an alarm. When a person attempts to remove an article without authorization, the reader detects the transponder tag that has not been disabled or removed from the article and sounds the alarm.

As transportable digital recording media is often small and easily concealed, EAS systems are easily overcome by simply removing the desired recording medium from its packaging, concealing the medium and then removing the medium. After the medium is removed, the data thereon can generally be copied easily. Placing RFID directly on the digital recording medium has been ruled out for several reasons, including the cost of the recording medium, the difficulty in placing the RFID in a manner to provide a read through a package, and the radio frequencies employed by such systems not being approved for in-flight use.

Theft may also occur when the purveyor of merchandise allows customers or distributors to freely return merchandise even in the absence of proof of purchase, if the merchandise being returned is carried by the sales outlet. Some persons purchase merchandise at reduced sale prices, or pilfer such merchandise, and then return the merchandise to the same or another purveyor for exchange or refund, claiming to have paid full price for the merchandise. In respect of digital recording media, a request for a refund may come after the content of the digital recording medium has been downloaded. If the purveyor refunds the full price, the purveyor loses the amount in excess of the purchase price in addition to the cost of processing the returned merchandise.

Another problem associated with software, whether licitly obtained or illicitly obtained, is that software may be easy to copy and reproduce using easily available technology.

There is a need for improved anti-theft recording medium system, particularly for digital recording medium.

### Definitions

“Digital Datum Indicia”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a digital data read.

“Digital Reader”: any device capable of detecting and reading digital information that has been recorded on an Digital Recording Medium. By the term “reader” it is meant to include, without limitation, a player. Examples are CD and DVD readers.

“Digital Recording Medium”: a medium of any geometric shape (not necessarily circular) that is capable of storing information in digital form thereon. Digital Recording Medium includes, without limitation, CD, DVDs, HD-DVDs, electromagnetic tape and disks, flash drives and Optical Medium. Information stored on the medium may include, without limitation, software programs, software data, sensory files, audio files and video files.

“Light-Activated State-Change Material”: a State-Change Material that alters a measurable parameter upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader (as defined below) for the reading of Optical Medium.

“Permanent State-Change Material”: a State-Change Material that once activated to change a measurable parameter upon application of energy to the material, stays in such state permanently or for a prolonged period of time.

“State-Change Material”: a material capable of altering a measurable property of the material upon activation of the material by application of energy to the material. “State-Change Material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure, materials that shrink upon application of heat) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material, spontaneously in a short period of time (minutes or less), loses such change in the measurable property. It includes, without limitation, materials that move from a first state to a second state upon application of energy, and back to the first state without application of energy.

“Transportable Recording Medium”: a relatively small medium capable of being transported by hand from one location to another. It includes, without limitation, Transportable Digital Recording Medium such as an optical disc, a floppy disk, a flash drive.

For the purpose of the rest of the disclosure, it is understood that the terms as defined above are intended, whether such terms are in initial cap or not.

### SUMMARY OF THE INVENTION

In an embodiment, there is disclosed a system for reducing supply chain theft comprising a: a Digital Recording Medium readable by digital reader producing a read-wave, such as an electromagnetic or sound wave, the medium having a State-Change Material associated therewith that is activatable from a first detectable state to a second detectable state by an activating wave (such as an electromagnetic or sound wave) that is energetically different (such as of a different wavelength, strength, characteristic) from the read-wave of the reader, the State-Change Material operatively applied to such medium to prevent read by the reader of at least a portion of the Digital Recording Medium in its first state but to allow read by the reader of the at least a portion of the Digital Recording Medium when it is in its second state; an activation unit operatively configured to direct activating waves to the medium such that State-Change Material associated with such medium is activated from a first state to a second state (such as optical state); and optionally a verifier unit operatively configured to determine whether the State-Change Material is its first or second state.

In another embodiment, there is disclosed the Digital Recording Medium may record data in Digital Datum Indicia and may be readable by a Digital Reader. The Digital Recording Medium may be an Optical Medium capable of being read by an Optical Reader. The Digital Recording Medium may be a Transportable Recording Medium. The State-Change Material may be a one-way State-Change Material, and may be a permanent one-way state-change material or a time-sensitive one-way State-Change Material, such that it changes from a first state to a second state and then slowly (matter of days or hours) reverts back to the first state or a third state. The State-Change Material may be a Temporary State-Change Material. The Digital Recording Medium may further comprise Transient State-Change Materials that are affixed in a manner described in the applications of Selinfreund to produce a copy-protected Digital Recording Medium.

In yet another embodiment, there is disclosed an Optical Medium having data indicia thereon readable by an Optical Reader producing a read-wave, the Optical Medium comprising: a one-way State-Change Material associated with read-corrupting error/invalid data incorporated into the Optical Medium, the one-way State-Change Material being activatable from a first state to a second state by an activating wave that is energetically different from the read-wave of the Optical Reader, the one-way State-Change Material selected and positioned with respect to the read-corrupting error/invalid data to permit read of the read-corrupting error/invalid data read by the Optical Reader when in a first state but to block read by the Optical Reader of the read-corrupting error/invalid data read when in its second state.

In one embodiment, there is disclosed a system for reducing supply chain theft comprising: a Digital Recording Medium readable by an Digital Reader producing a read-wave, the medium having a one-way State-Change Material associated therewith that is activatable from a first detectable state to a second detectable state by an activating wave that is energetically different from the read-wave of the Digital Reader, the one-way State-Change Material operatively applied to such medium to prevent read by the Digital Reader of at least a portion of the medium in its first optical state but to allow read by the Digital Reader of the at least a portion of the medium when it is in its second optical state; an activation unit operatively configured to direct activating waves to the medium such that one-way State-Change Material associated with the medium is activated from the first optical state to the second optical state; and a verifier unit operatively configured to determine whether the one-way State-Change Material is its second optical state.

In yet another embodiment, there is disclosed an activation-verifier unit for activating, and verifying activation of, an Optical Medium comprising a one-way State-Change Material that is activatable from a first detectable state to a second detectable state by an activating wave that is energetically different from the read-wave of the Optical Reader, the one-way State-Change Material operatively applied to such Optical Medium to prevent read by the Optical Reader of at least a portion of the Optical Medium in its first optical state but to allow read by the Optical Reader of the at least a portion of the Optical Medium when it is in its second optical state, the activator-verifier comprising: one or more energy emitters operatively configured to emit the activating wave towards the Optical Medium; one or more energy emitters operatively configured to emit a verification wave towards the Optical Medium; one or more verification detectors operatively configured to receive responsive transmissions after emission of the verification wave towards the Optical Medium and to produce a processable signal; and a processor operatively configured to process the signals from the verification detectors to determine whether the Optical Medium has been exposed to an activating wave so as to make the Optical Medium readable.

### BRIEF DESCRIPTION OF THE DRAWINGS

Various of the above mentioned and further features and advantages will be better understood from this description of embodiments thereof, including the attached drawing figures wherein:

FIG. 1 is an illustration of an optical disc recording medium with multiple layers; and

FIG. 2 is an illustration of an activator/verifier embodiment unit.

### DETAILED DESCRIPTION OF THE INVENTION

In one embodiment, there is disclosed system for reducing supply chain theft comprising a medium having a State-Change Material associated therewith that is activatable from a first detectable state to a second detectable state by an activating wave that is energetically different from the read-wave of the reader, thereby altering the medium from a limited read medium to a more open read medium; an activation unit operatively configured to direct activating waves to the Optical Medium such that one-way State-Change Material associated with such Optical Medium is activated from a first state to a second; and a verifier unit operatively configured to determine whether the one-way State-Change Material is its first or second optical state.

In one embodiment, the State-Change Material of the medium is a one-way State-Change Material that is associated with the medium (e.g., in or on the medium) to cause otherwise valid data indicia on the medium that is representative of information stored on the disc to be unreadable by a reader designed to read such medium when such State-Change Material is in its first optical state, but to be readable when such State-Change Material is in its second optical state. The State-Change Material may be, for example, a Light-Activated State-Change Material. The State-Change Material may be a Permanent State-Change Material or a Temporary State-Change Material. The selection of the type of State-Change Material to be applied to the medium may relate to the effect one wishes to produce. For example, a Permanent State-Change Material may be selected so that once activation is accomplished and the State-Change Material moves to a state wherein read can occur, the Optical Medium remains readable. However, a Temporary State-Change Material may be selected when one wishes the medium to be read only for a set duration of time after activation.

In one aspect of such embodiment, the medium is an Optical Medium and the state change is an optical state change. In such aspect, the first optical state of a one-way State-Change Material blocks transmission of the read-wave of the Optical Reader to at least a portion of valid data indicia on the Optical Medium, blocking read of such data indicia. However, the second optical state of the one-way State-Change Material is chosen to permit transmission of the read-wave of the Optical Reader to the data indicia on the disc, allowing the valid data indicia to be read. For example, the State-Change Material may be an optical State-Change Material that in its first state is opaque but in its second state is bleached so as to be transmissive.

In another aspect, the first state of a one-way State-Change Material is associated with the Optical Medium in a manner such that permits transmission of the read-wave of the Optical Reader to at least a portion of indicia on the Optical Medium which relates to a read-corrupting error/invalid state of such a character that it interferes with read of the Optical Medium (or at least a portion of the data recorded on the Optical Medium). However, the activated second optical state of the one-way State-Change Material blocks transmission of the read-wave of the Optical Reader to the read-corrupting error/invalid data indicia on the Optical Medium, allowing the medium to be fully read.

In another aspect, the one-way State-Change Material is selected such that, and associated with data indicia on the optical manner in a manner such that, in its first optical state an Optical Reader of the medium detects a read-corrupting error/invalid state that corrupts read of the medium at the location(s) of the medium associated with the one-way State-Change Material, blocking read of the Optical Medium (or a portion thereof). However, the one-way State-Change Material is selected such that, and associated with data indicia on the optical manner in a manner such that, upon activation of the one-way State-Change Material to the second optical state, the Optical Reader of the medium detects either a valid read state, or a non-read-corrupting error/invalid read state, at the location(s) of the medium associated with the one-way State-Change Material, permitting read of the Optical Medium (or portion thereof). For example, the State-Change Material may be an optical State-Change Material that in its first state is opaque and in its second state transmissive. The State-Change Material may be positioned on an optical disc in a manner such that it alters the true read of the pit/land data structures in its first optical state due to its optical masking of one or more pits/lands to cause the error/invalid read state. Yet when activated to its second optical state it may allow for true read of the optical media causing a valid data read.

In yet another embodiment, more than one State-Change Material is employed to cause a change in data read so as to make the Optical Medium, or a portion of the Optical Medium, unreadable prior to activation of one or more (or all) of the State-Change Materials but readable after activation of one or more (or all) of the State-Change Materials. For example, two optical State-Change Materials may be employed which produce different second optical states upon activation with the activation wave and each may be selectively associated with the data indicia on the medium in a manner such that read of the medium (or portion of the medium) is blocked due to their positioning and first optical state with respect to the data indicia, but upon activation due to the change to the second optical state allow read of the medium, or the portion of the medium. As should be understood, any combination of changes in state, and any number of State-Change Materials, can be used to effectuate the anti-theft protection, as long as read of the medium, or portion of the medium, desired to be blocked, is blocked by appropriate positioning of each of the materials with respect to the data indicia on the medium when the materials are in their first state, but are unblocked when one or more (or all) of such materials are activated by an activation wave, such as an electromagnetic or sound wave, and one or more (or all) of such materials are in their second state. For example, one State-Change Material may have a first optical state that is opaque, and a second optical state that is transmissive of a read-wavelength of an Optical Reader, while another State-Change Material employed may have its first optical state that is transmissive of the read-wavelength of the optical read, and a second optical state that blocks transmission.

In yet another embodiment, the medium includes non-nominal data indicia that act as security regions.

In yet another embodiment, the anti-theft composition comprises an limited-time play composition comprising a time-delayed multi-State-Change Material. Such limited-time play composition may, for example, comprise a State-Change Material that blocks in its first state the read of the medium or portions of the medium), that converts upon activation by an activation wave to a second state which allows read of the medium, and over a period of time reverts from the second state to the first state or a changes to a third state that blocks read of the Optical Medium. Such time-delayed State-Change Material or composition may be further selected such that it may be reverted back from the third state or first state to a state that allows read of the Optical Medium by application of an energy source (for example, by impingement with an emission source).

Such above embodiments may further entail software on the medium or associated with the reader of the medium (or ancillary device associated with the reader) that allows full or more expansive read of the medium only upon recognition by the software that one or more State-Change Materials on the medium is correctly positioned with respect to an authentic medium and/or has parametric measurements or a fingerprint associated with authentic State-Change Material which should be associated with the medium. The software may include a protocol to cause the reader to provide input to the program with respect to the placement of the State-Change Material and/or parametric measurements of the State-Change Material (such as, without limitation, opacity, reflectivity etc.), advantageously in its second state (that is, after activation). By inclusion of such software, illicit copying of the activated software is dissuaded in that the medium must include specified material correctly positioned with respect to the data being copied in order for the medium to be read fully.

When security non-nominal data indicia are included on the medium, such as Optical Medium, such above embodiments may further entail software on the medium or associated with the reader of the medium, or ancillary device associated with the reader, that allows full or more expansive read of the medium only upon recognition by the software of such security non-nominal data. For example, the State-Change Material may be selected and positioned with respect to the non-nominal data indicia region, comprising for example a number non-nominal depth pits on a pit/land Optical Medium, such that the State-Change Material in its first state does not allow read of the non-nominal data indicia region until activation by an activation wave, but does allow read of such non-nominal depth pits when the State-Change Material is in its second state. The software may include an instruction set or module that prohibits read of the medium in full without detection of the security non-nominal data indicia region. Thus such non-nominal data indicia may in itself, or in conjunction with the State-Change Material, act as a security code for determining whether a medium is authorized for reading. Before activation of the State-Change Material, the material in conjunction with the non-nominal data indicia region may cause, for example, an error state, but after activation to its second state allow for a valid data read of the non-nominal data indicia region. For example, the State-Change Material may induce an error over the security region of the medium in its first state by softening the pit/land transitions associated with a valid read, but in its second state allow read of such transitions by revealing valid security pit transitions.

The State-Change Material may be applied in any manner to the medium provided it produce the read deficiency desired when it is in its first state, but allows for read when it is in its second state, and its application does not inhibit the activation by a activating wave directed at the medium. In one embodiment, the State-Change Material is applied in a coating that is placed on the medium in its manufacturing process, or applied post process. Application of such coating should take into account the type of activating wave being employed, and the penetration of the wave into the medium in the direction of propagation of the wave. For example, ultraviolet light frequencies are not easily transmitted in polycarbonate, the material from which many Optical Medium, such as DVDs and CDs, are constructed. If the activation wave is an ultraviolet wave, therefore, it might be advantageous to place the State-Change Material in a layer, such as a coating layer (e.g., the acrylic layer of a DVD or CD which does transmit UV activation frequencies), on the laser read side of the Optical Medium. Of course, advantageously the State-Change Material may be applied to the medium in a manner that it is not easily removed from the medium to dissuade end-runs around the anti-theft security feature. For example, one might wish to cross link ultraviolet activators (such as those activated at 365 nm) to the medium to prevent removal of the same through the application of common solvents that do not effect the actual underlying data indicia structure (e.g., one might wish to increase “rub resistance”). When coatings associated with the State-Change Material are used, one may wish to reduce coat thickness to reduce activation time (as well as to reduce material cost).

The optical density of an anti-theft composition coating, if employed, may be selected to allow passage of the activation wave, while blocking read-waves of a reader when the State-Change Material is in its first state and read is desired to be blocked. For example, an optical density of 1 OD may be selected. Thus, for example, the coating may be manufactured to allow a UV activation wave of a frequency of about 250 to about 290 nm to pass into the coating (e.g., acrylates may be used that allow passage of about 270 nm of light) and activate the State-Change Material, while blocking read-waves of frequencies of about 405 nm, about 650 nm and about 780 nm, associated with BD/HD/DVD/CD read lasers.

An anti-theft composition coating may be optimized by first determining the quantum efficiency (how many photons are required to activate the State-Change Material at the activation wavelength) of the composition before application to representative medium and then optimizing the quantum efficiency to a on the Optical Medium with different thin film coatings using a diffuse reflectance measurement.

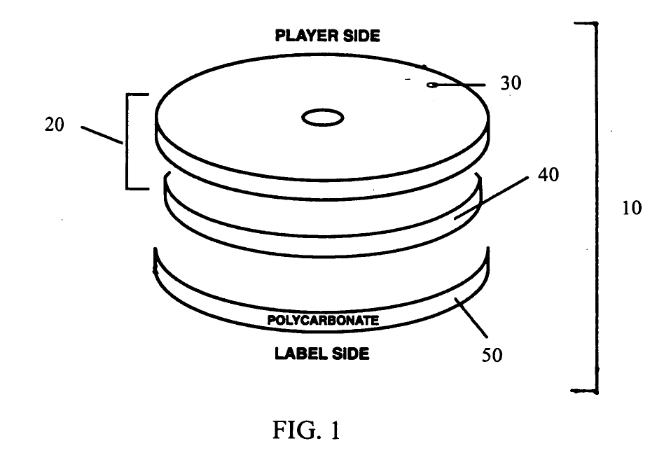

Turning to FIG. 1, there is shown an embodiment theft-protected Optical Medium 10, having a multi-layer cap 20 comprised of a theft-protected coating acrylic layer 30 comprising a State-Change Material capable of photo-activation with a UV activation wave of a frequency of about 250 to about 290 nm, and a anti-copy layer 40 comprising Transient State-Change Material that is activatable by the read-wave of an Optical Reader designed to read the Optical Medium from a first state to a second state, the second state of which spontaneously returns to the first state. Cap 20 is associated with a polycarbonate layer 50 of Optical Medium 10 in which data indicia are placed (not shown) so as to cap the same.

In a system embodiment for reducing theft of optical media from a distribution chain, there is included an activator unit that produces an activation wave that activates the State-Change Material such that it moves from a first state, such as first optical state, to a second state, such as a second optical state, that have different properties in respect of a the read-wave of the Optical Reader designed to read the Optical Medium (such different properties, and the position of the State-Change Material with respect to the Optical Medium, being selected to prohibit read of at least a portion of the Optical Medium when the State-Change Material is in its first state, but unblock such prohibition when the State-Change Material is in its second state). The activation unit may comprise a housing defining a void, the housing comprising a one or more energy sources capable of emitting an activation unit towards an area within the void through which the anti-theft protected optical media may be passed. In an embodiment of the activating unit, there is provided an activating unit that produces an activation wave, such as an electromagnetic or sound wave, that can penetrate the packaging placed about an Optical Medium to protect such Optical Medium from handling damage and still cause the conversion of the first optical state to a second optical state. The activator may be configured to emit a tone or other sensory signal when the reflected etc. light is indicative of an Optical Medium that is readable (or alternatively non-readable).

In a system embodiment for reducing theft of optical media from a distribution chain, there may also be included a verification unit for detecting whether a theft-protected Optical Medium has been activated by an activation unit. Verification unit may comprise an array of emitters producing authentication waves that are positioned so as to direct authentication waves toward an anti-theft protected Optical Medium, and sensors positioned so as to receive reflected or otherwise responsive emissions (that is to the emitted waves of the emitters). The verification unit may further comprise a processor operatively configured to receive input from the optical sensors and to process the input to determine if the input is indicative of an Optical Medium in which read has been activated. In an embodiment of the verification unit, there is provided an verification unit that produces an authentication wave, such as an electromagnetic or sound wave, that can penetrate the packaging placed about an Optical Medium to protect such Optical Medium from handling damage and still detect whether there was a conversion of the first optical state to a second optical state, that is that the medium is readable.

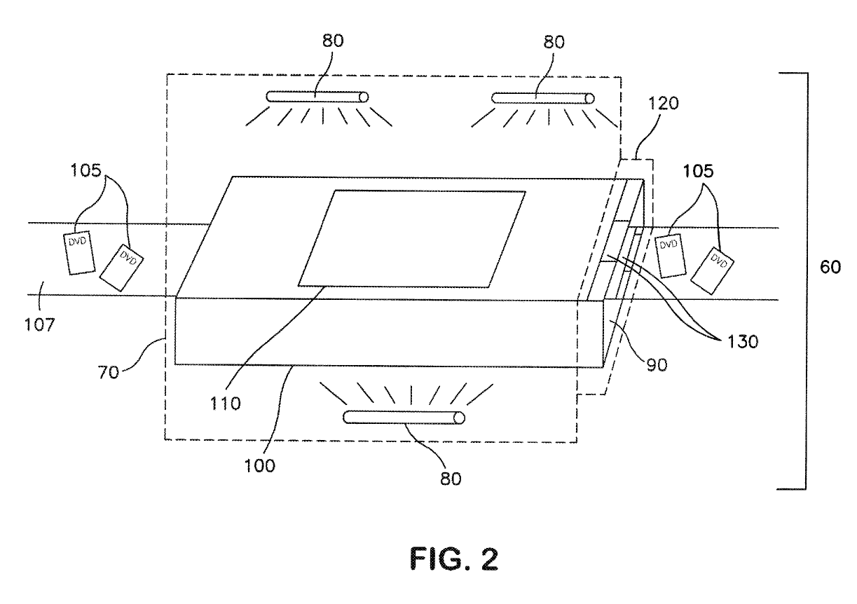

Turning to FIG. 2, there is shown an embodiment combination activator/verifier unit 60. Unit 60 comprises an activator 70 having one or more light sources 80 directed at a void 90 within housing 100 through which optical media packages 105 may be passed (a conveyor belt 107 is shown in the illustration as aiding movement through unit 60). Light sources 80 may emit an activation wave at a wavelength (such as ultraviolet) and/or intensity such that for safety reasons they may be placed into void 90. A filter (not shown) may be employed in conjunction with light sources 80, to filter out waves that might interfere in the activation of Optical Medium or which may reduce the efficacy of activation. A protection panel 110 may be included in the fabrication to also provide protection. As shown in the figure, light sources 80 may be positioned so as to allow for activation waves being emitted toward any package entering void 90 from both the top and bottom. The latter enable activation of the anti-theft optical State-Change Material whether the package is placed into the activation unit laser read side up or down. As would be understood, light sources 80, while shown for ease of representation as outside of housing 100, may be found within housing 100. Combination activator/verifier unit 60 further includes a verification unit 120 which comprises an array of emitter/detector 130 on both the top and bottom surface of the unit which emit authentication waves that are received by the Optical Medium packages and then detect responsive waves. Arrays 130 are connected to a processor (not shown) which then determines if the responsive waves received by the detectors are indicative of an Optical Medium in which block of read has been unblocked.

### Statement Regarding Preferred Embodiments

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. An optical medium having data indicia thereon readable by an optical reader producing a read-wave, said optical medium comprising:
a one-way state-change material associated with read-corrupting error/invalid data incorporated into the optical medium, said one-way state-change material being activatable from a first state to a second state by an activating wave that is energetically different from the read-wave of the optical reader, the one-way state-change material selected and positioned with respect to the read-corrupting error/invalid data to permit read of the read-corrupting error/invalid data read by said optical reader when in a first state but to block read by said optical reader of said read-corrupting error/invalid data read when in its second state.

2. An optical medium according to claim 1 wherein the optical medium further comprises non-nominal data indicia.

3. (canceled)

4. An optical medium according to claim 1 wherein the one-way state-change material is a one-way optical state-change material.

5. An optical medium according to claim 1 wherein the optical medium is an optical disc, a CD or DVD.

6. An optical medium according to claim 1 wherein when said one-way state-change material is in its second state, the data stored on the optical medium is freely readable.

7. A system for reducing supply chain theft comprising:
a digital recording medium readable by an digital reader producing a read-wave, the medium having a one-way state-change material associated therewith that is activatable from a first detectable state to a second detectable state by an activating wave that is energetically different from the read-wave of the digital reader, the one-way state-change material operatively applied to such medium to prevent read by the digital reader of at least a portion of the medium in its first optical state but to allow read by the digital reader of the at least a portion of the medium when it is in its second optical state;
an activation unit operatively configured to direct activating waves to the medium such that one-way state-change material associated with such medium is activated from said first optical state to said second optical state; and
a verifier unit operatively configured to determine whether the one-way state-change material is its second optical state.

8. An activation-verifier unit for activating, and verifying activation of, an optical medium comprising a one-way state-change material that is activatable from a first detectable state to a second detectable state by an activating wave that is energetically different from the read-wave of the optical reader, the one-way state-change material operatively applied to such optical medium to prevent read by the optical reader of at least a portion of said optical medium in its first optical state but to allow read by the optical reader of the at least a portion of said optical medium when it is in its second optical state, said activator-verifier comprising:
one or more energy emitters operatively configured to emit the activating wave towards said optical medium;
one or more energy emitters operatively configured to emit a verification wave towards said optical medium;
one or more verification detectors operatively configured to receive responsive transmissions after emission of said verification wave towards said optical medium and to produce a processable signal; and
a processor operatively configured to process the signals from said verification detectors to determine whether the optical medium has been exposed to an activating wave so as to make the optical medium readable.
